(19) United States
(12) Patent Application Publication
(10) Pub. No.: US 2018/0224806 A1
(43) Pub. Date: Aug. 9, 2018

(54) WEARABLE ELECTRONIC DEVICE

(71) Applicants: Inventec Appliances (Pudong) Corporation, Shanghai (CN); Inventec Appliances Corp., New Taipei City (TW); Inventec Appliances (Shanghai) Co., Ltd., Shanghai (CN)

(72) Inventors: Jing-Song CHANG, Shanghai (CN); Shih-Chin TSENG, Shanghai (CN); Li-Juan WEI, Shanghai (CN)

(21) Appl. No.: 15/826,719

(22) Filed: Nov. 30, 2017

(30) Foreign Application Priority Data
Feb. 4, 2017 (CN) 201710064407.4

(51) Int. Cl. G04G 19/10; G06F 1/26

(52) U.S. Cl. CPC G04G 19/10; G06F 1/266

(57) ABSTRACT

A wearable electronic device includes a host, a wearing member, and a backup power module. The host includes a functional module, a main power module, and an electrical connection port. The main power module is configured to supply power to the functional module. The electrical connection port is electrically connected to the main power module. The wearing member is connected to the host. The backup power module is detachably disposed at an upper region or a surrounding region of the host to electrically couple the electrical connection port, or is detachably disposed on the wearing member and configured to electrically couple the electrical connection port to supply power to the main power module.

### RELATED APPLICATIONS

This application claims priority to China Application Serial Number 201710064407.4, filed Feb. 4, 2017, which is herein incorporated by reference.

### BACKGROUND

### Technical Field

The present disclosure relates to a wearable electronic device, and more particularly, to a wearable electronic device that can replace a battery.

### Description of Related Art

With the progress of wearable electronic devices, many functionally oriented wearable electronic devices, such as smart watches or smart wristbands having functions such as GPS (Global Positioning System) function, heartbeat sensing, pace counting, and communicating are popular with consumers.

However, electronic devices having more functions tend to consume more power. Owing to sizes of wearable electronic devices are limited, capacities of batteries installed therein cannot be large, which cause the users to face the dilemma that the electronic devices may be charged every day.

Accordingly, how to provide a wearable electronic device to solve the aforementioned problems becomes an important issue to be solved by those in the industry.

### SUMMARY

An aspect of the disclosure is to provide a wearable electronic device which can be easily charged.

According to an embodiment of the disclosure, a wearable electronic device includes a host, a wearing member, and a backup power module. The host includes a functional module, a main power module, and an electrical connection port. The main power module is configured to supply power to the functional module. The electrical connection port is electrically connected to the main power module. The wearing member is connected to the host. The backup power module is detachably disposed at an upper region of the host to electrically couple the electrical connection port, so as to supply power to the main power module.

In an embodiment of the disclosure, the backup power module is rotatably sleeved onto an outer edge of the wearing member.

In an embodiment of the disclosure, the wearing member has a first engagement structure. The backup power module has a second engagement structure. The wearing member and the backup power module rotating relative to each other make the first engagement structure be selectively engaged with the second engagement structure.

In an embodiment of the disclosure, the electrical connection port is disposed at an outer edge of the host. The wearing member further includes a relay contact coupled to the electrical connection port. The backup power module further includes a power contact. When the first engagement structure and the second engagement structure are engaged with each other, the power contact is coupled to the relay contact.

According to another embodiment of the disclosure, a wearable electronic device includes a host, a wearing member, and a backup power module. The host includes a functional module, a main power module, and an electrical connection port. The main power module is configured to supply power to the functional module. The electrical connection port is electrically connected to the main power module. The wearing member is connected to the host. The backup power module is detachably disposed at a surrounding region of the host to electrically couple the electrical connection port, so as to supply power to the main power module.

In an embodiment of the disclosure, the electrical connection port is disposed at a back surface of the host.

In an embodiment of the disclosure, the wearing member includes a sleeve portion. The sleeve portion is sleeved onto an outer edge of the host and at least exposes the electrical connection port. The backup power module further includes an abutting portion, an extending portion, and a power contact. The abutting portion is configured to abut against the sleeve portion. The extending portion is connected to the abutting portion and configured to face the back surface of the host when the abutting portion abuts against the sleeve portion. The power contact is disposed at the extending portion and configured to couple the electrical connection port.

According to another embodiment of the disclosure, a wearable electronic device includes a host, a wearing member, and at least one backup power module. The host includes a functional module, a main power module, and at least one electrical connection port. The main power module is configured to supply power to the functional module. The electrical connection port is electrically connected to the main power module. The backup power module is detachably disposed on the wearing member and configured to electrically couple the electrical connection port to supply power to the main power module.

In an embodiment of the disclosure, the wearing member includes a wearing portion. The wearing portion has at least one accommodating space configured to accommodate the backup power module. The accommodating space is connected to an edge of the host. The electrical connection port is located at the edge.

In an embodiment of the disclosure, the accommodating space is an indentation.

In an embodiment of the disclosure, the wearing portion is configured to surround to form a wearing space. The indentation and the wearing space are respectively located at opposite sides of the wearing portion.

In an embodiment of the disclosure, a housing of the backup power module has at least one battery bay. The battery bay is configured to accommodate an external battery. The backup power module further includes a conductive contact. The conductive contact is disposed in the battery bay and configured to couple the external battery, so as to make the external battery supply power to the backup power module.

In an embodiment of the disclosure, the backup power module is accommodated in the indentation and coupled to the electrical connection port. The battery bay faces a bottom of the indentation.

In an embodiment of the disclosure, the wearing member includes a wearing portion. The wearing portion has at least one accommodating space configured to accommodate the backup power module. The accommodating space is a hollow portion.

In an embodiment of the disclosure, the host further includes a chassis. The functional module and the main power module are disposed in the chassis. The chassis has a slot. The electrical connection port is disposed in the slot. The backup power module is configured to insert into the slot to electrically couple the electrical connection port.

In an embodiment of the disclosure, the wearing member includes a wearing portion and a sleeve portion. The sleeve portion is connected to the wearing portion and sleeved onto an outer edge of the chassis.

In an embodiment of the disclosure, the sleeve portion has a guide groove configured to guide the backup power module to insert into the slot.

In an embodiment of the disclosure, the backup power module has an insertion portion and a power contact disposed on the insertion portion. The wearing member includes at least one wearing portion and at least one wire. The wearing portion has at least one through hole configured to be inserted by the insertion portion. The wire is embedded in the wearing portion and coupled to the electrical connection port. When the insertion portion inserts into the through hole, the power contact is coupled to the wire via an inner wall of the through hole, so as to make the backup power module to supply power to the main power module.

In an embodiment of the disclosure, two of the wearing portions surround to form a wearing space. Each of the wearing portions has a plurality of through holes. The insertion portion is configured to selectively insert into one of the through holes of one of the wearing portions and one of the through holes of another of the wearing portions, so as to adjust a size of the wearing space.

In an embodiment of the disclosure, the backup power module further has a head portion connected to the insertion portion. An outer diameter of the head portion is greater than a diameter of the through hole.

Accordingly, the wearable electronic device of the present disclosure allows the backup power module to be detachably disposed at an upper region or a surrounding region of the host to supply power to the main power module, or to be detachably disposed on the wearing member and configured to electrically couple the electrical connection port to supply power to the main power module. Therefore, the wearable electronic device of the present disclosure can conveniently supply power to the main power module in the host by using the backup power module, and the backup power module does not affect user's wear comfort and the functional operations on the host during charging.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1A is a perspective view of a wearable electronic device according to an embodiment of the disclosure;

FIG. 1B is an exploded view of the wearable electronic device shown in FIG. 1A;

FIG. 2 is a perspective view of a backup power module shown in FIG. 1A;

FIG. 3 is a perspective view of a wearable electronic device according to another embodiment of the disclosure, in which a backup power module does not abut against a wearing member;

FIG. 4 is a perspective view of a host shown in FIG. 3;

FIG. 5 is a perspective view of a wearable electronic device according to another embodiment of the disclosure, in which backup power modules are separated from a wearing member;

FIG. 6 is a perspective view of a wearable electronic device according to another embodiment of the disclosure, in which backup power modules are separated from a wearing member;

FIG. 7 is an exploded view of a backup power module shown in FIG. 6;

FIG. 8 is a perspective view of a wearable electronic device according to another embodiment of the disclosure, in which backup power modules are separated from a wearing member; and

FIG. 9 is an exploded view of a wearable electronic device according to another embodiment of the disclosure, in which a backup power module is separated from a wearing member.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

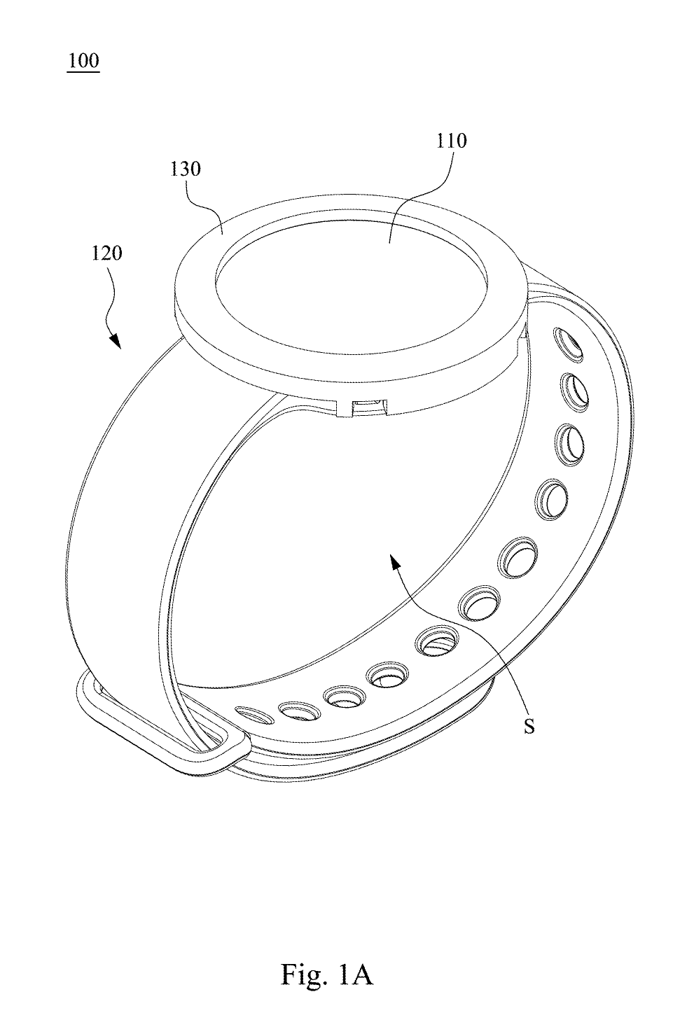

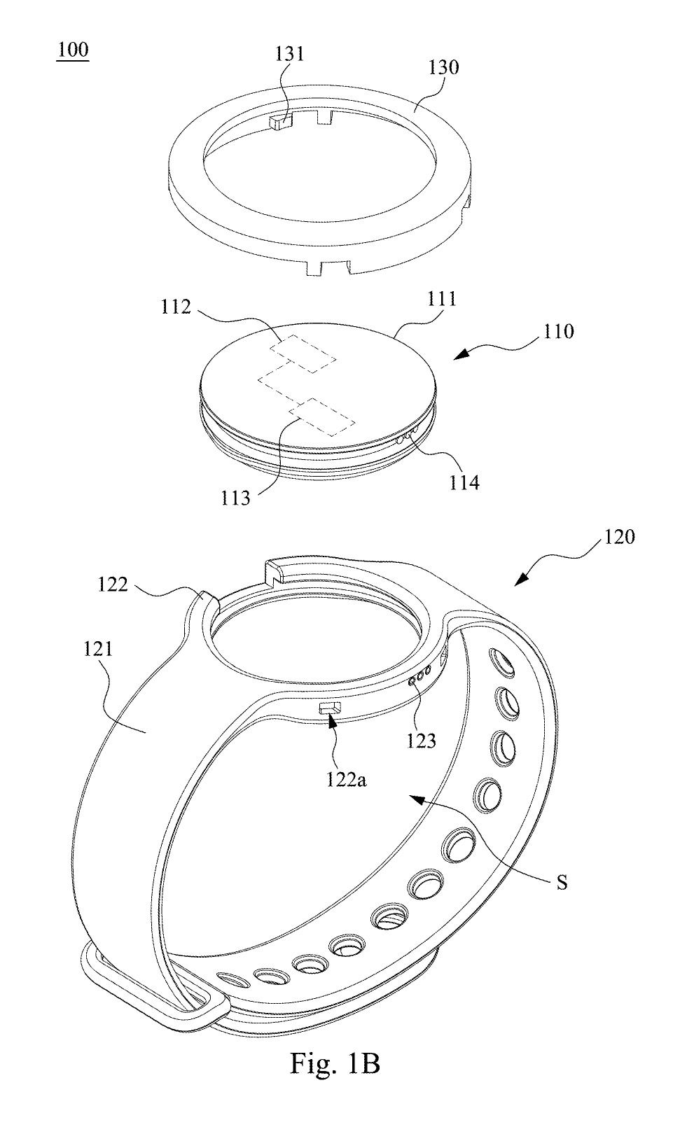

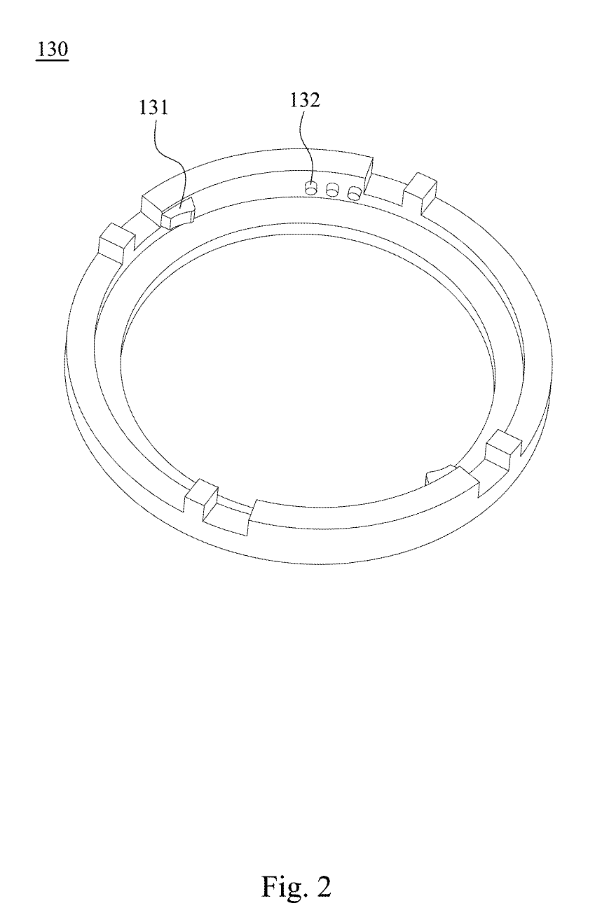

Reference is made to FIGS. 1A-2. FIG. 1A is a perspective view of a wearable electronic device 100 according to an embodiment of the disclosure. FIG. 1B is an exploded view of the wearable electronic device 100 shown in FIG. 1A. FIG. 2 is a perspective view of a backup power module 130 shown in FIG. 1A. As shown in FIGS. 1A-2, in the embodiment, the wearable electronic device 100 includes a host 110, a wearing member 120, and the backup power module 130. The host 110 includes a chassis 111, a functional module 112, a main power module 113, and an electrical connection port 114. The functional module 112 and the main power module 113 are disposed in the chassis 111, so they are shown in dashed lines in the figures. The functional module 112 can be a module for performing a specific function in the host 110, such as a display module, a communication module, a touch module, a data transmission module, etc., but the present disclosure is not limited in this regard. The main power module 113 is configured to supply power to the functional module 112. The electrical connection port 114 is disposed at an outer edge of the chassis 111 and electrically connected to the main power module 113. The wearing member 120 is connected to the host 110. The backup power module 130 is detachably disposed at an upper region of the host 110 to electrically couple the electrical connection port 114, so as to supply power to the main power module 113.

Specifically, the wearing member 120 includes a wearing portion 121 and a sleeve portion 122. The sleeve portion 122 is sleeved onto the outer edge of the chassis 111 of the host 110 and at least exposes a front surface of the host 110. For example, the front surface of the host 110 can be a display surface of a display module or a touch surface of a touch module, but the present disclosure is not limited in this regard. The wearing portion 121 is connected to the sleeve portion 122 and configured to wrap around a user's body (e.g., arm, wrist, ankle, neck, or other parts). For example, the wearing portion 121 can be a strap or a collar, but the present disclosure is not limited in this regard.

In particular, the backup power module 130 of the present embodiment is rotatably sleeved onto an outer edge of the sleeve portion 122 of the wearing member 120. The backup power module 130 is ring-shaped, so as to expose the front surface of the host 110. Therefore, even though the backup power module 130 is disposed at the upper region of the host 110 to supply power to the main power module 113 in the chassis 111, a user can still operate on the front surface of the host 110 without any hindrance.

As shown in FIGS. 1B and 2, the wearing member 120 further has first engagement structures 122a. The backup power module 130 further has second engagement structures 131 (only one of the second engagement structures 131 is labeled in FIG. 2). The wearing member 120 and the backup power module 130 rotating relative to each other make the first engagement structures 122a be selectively engaged with the second engagement structures 131. In the present embodiment, the first engagement structures 122a of the wearing member 120 are engaging grooves formed on the sleeve portion 122, and the second engagement structures 131 of the backup power module 130 are engaging blocks, but the present disclosure is not limited in this regard.

In addition, in the present embodiment, the wearing member 120 further includes a relay contact 123. The relay contact 123 passes through the sleeve portion 122 and is coupled to the electrical connection port 114. The backup power module 130 further includes a power contact 132 (referring to FIG. 2). When the first engagement structures 122a and the second engagement structures 131 are engaged with each other, the power contact 132 is coupled to the relay contact 123. Therefore, the backup power module 130 can supply power to the main power module 113 in the chassis 111 sequentially via the power contact 132, the relay contact 123, and the electrical connection port 114, so as to supplement the power consumed by the main power module 113 to maintain the operation of the functional module 112. Furthermore, with the engaging design of the first engagement structures 122a and the second engagement structures 131, relative positions of the backup power module 130 and the sleeve portion 122 can be effectively fixed to ensure the power contact 132 can be firmly coupled to the relay contact 123.

In some embodiments, the appearance of the sleeve portion 122 can be modified to cancel the relay contact 123, and the backup power module 130 rotatable relative to the wearing member 120 can be modified to make the power contact 132 be able to directly couple the electrical connection port 114. Furthermore, the engaging grooves originally formed on the sleeve portion 122 can be formed on the chassis 111 of the host 110 instead, so that the backup power module 130 can be detachably disposed at the upper region of the host 110 and rotatably sleeved onto an outer edge of the chassis 111. In some embodiments, the relay contact 123 can be cancelled, and the sleeve portion 122 can be modified for the electrical connection port 114 to pass through to be contacted by the power contact 132. In some embodiments, the wearing member 120 can cancel the sleeve portion 122 and direct connect the outer edge of the chassis 111 with the wearing portion 121.

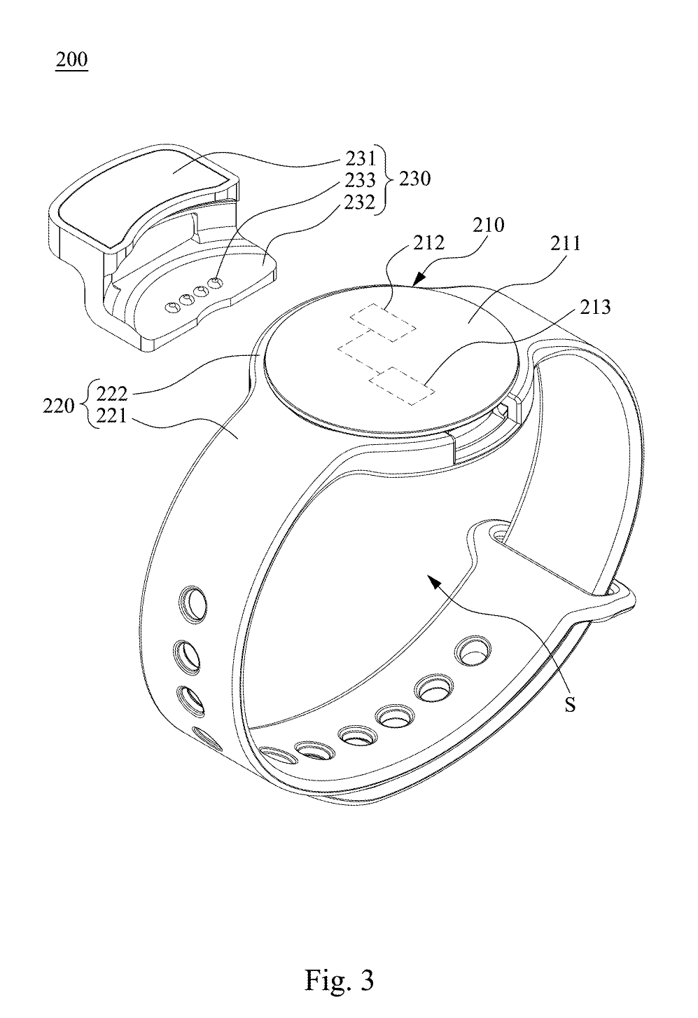

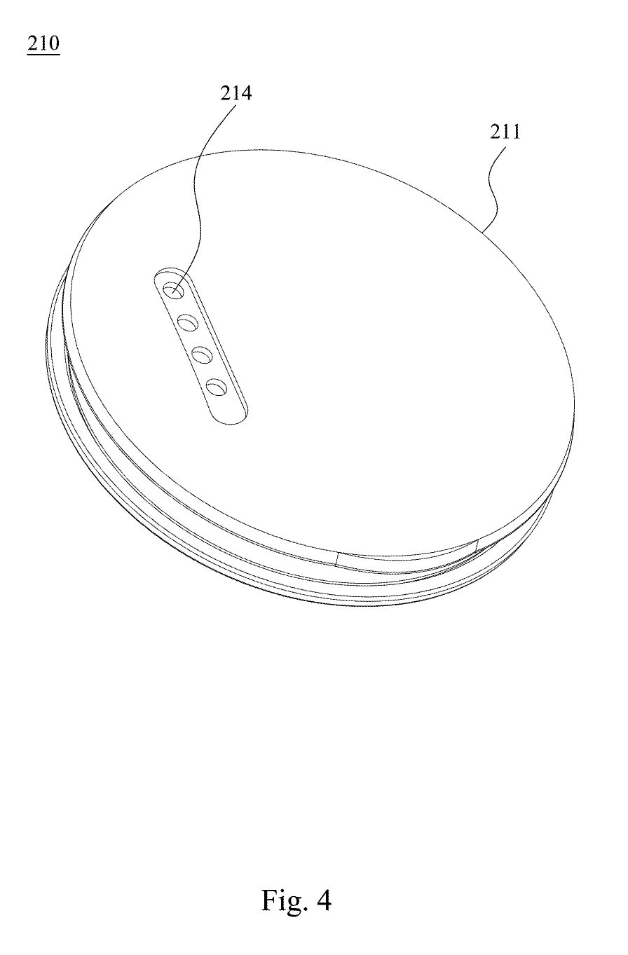

Reference is made to FIGS. 3 and 4. FIG. 3 is a perspective view of a wearable electronic device 200 according to another embodiment of the disclosure, in which a backup power module 230 does not abut against a wearing member 220. FIG. 4 is a perspective view of a host 210 shown in FIG. 3. As shown in FIGS. 3 and 4, in the present embodiment, the wearable electronic device 200 includes the host 210, the wearing member 220, and the backup power module 230. The host 210 includes a chassis 211, a functional module 212, a main power module 213, and an electrical connection port 214. The functional module 212 and the main power module 213 are disposed in the chassis 211, so they are shown in dashed lines in the figures. The main power module 213 is configured to supply power to the functional module 212. The electrical connection port 214 is electrically connected to the main power module 213. The wearing member 220 is connected to the host 210. The backup power module 230 is detachably disposed at a surrounding region of the host 210 to electrically couple the electrical connection port 214, so as to supply power to the main power module 213.

Specifically, the wearing member 220 includes a wearing portion 221 and a sleeve portion 222. The sleeve portion 222 is sleeved onto the outer edge of the chassis 211 of the host 210 and at least exposes a front surface and a back surface of the host 210, so as to expose the electrical connection port 214. The backup power module 230 further includes an abutting portion 231, an extending portion 232, and a power contact 233. The abutting portion 231 is configured to abut against the sleeve portion 222. The extending portion 232 is connected to the abutting portion 231 and configured to face the back surface of the chassis 211 of the host 210 when the abutting portion 231 abuts against the sleeve portion 222. The power contact 233 is disposed at the extending portion 232 and configured to couple the electrical connection port 214 located at the back surface of the host 210. Therefore, even though the backup power module 230 is disposed at the surrounding region of the host 210 to supply power to the main power module 213 in the chassis 211 (i.e., under the circumstances that a gap formed between the back surface of the host 210 and a user's body is enough for the extending portion 232 of the backup power module 230 to insert to make the power contact 233 on the extending portion 232 couple the electrical connection port 214), a user can still operate on the front surface of the host 210 without any hindrance.

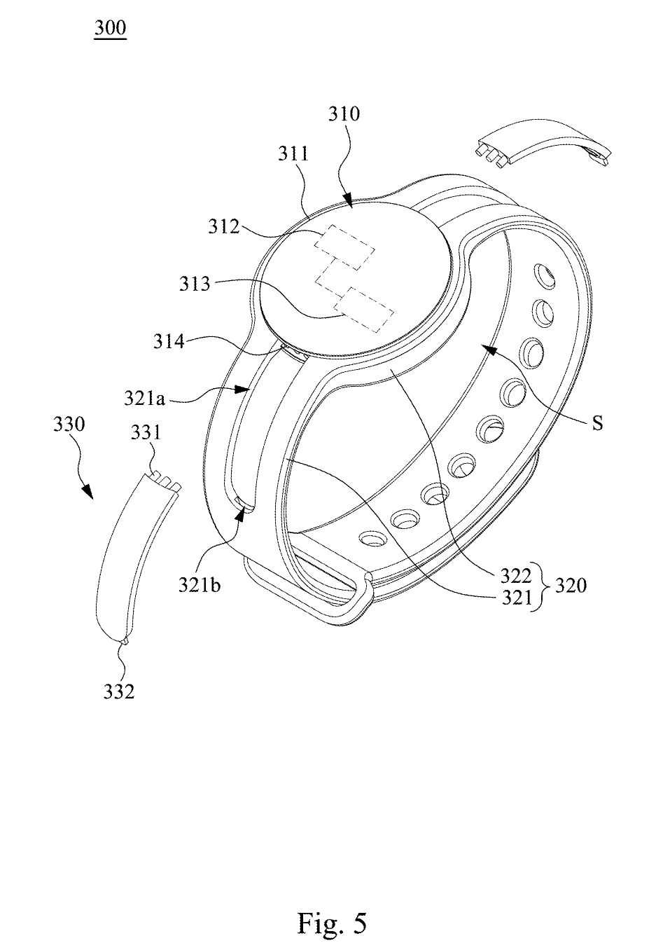

Reference is made to FIG. 5. FIG. 5 is a perspective view of a wearable electronic device 300 according to another embodiment of the disclosure, in which backup power modules 330 are separated from a wearing member 320. As shown in FIG. 5, in the present embodiment, the wearable electronic device 300 includes a host 310, the wearing member 320, and a plurality of the backup power module 330 (only one of the backup power modules 330 is labeled in FIG. 5). The host 310 includes a chassis 311, a functional module 312, a main power module 313, and a plurality of electrical connection ports 314. The functional module 312 and the main power module 313 are disposed in the chassis 311, so they are shown in dashed lines in the figure. The main power module 313 is configured to supply power to the functional module 312. The electrical connection ports 314 are electrically connected to the main power module 313. The backup power modules 330 are detachably disposed on the wearing member 320 to electrically couple the electrical connection port 314, so as to supply power to the main power module 313.

Specifically, the wearing member 320 includes a wearing portion 321 and a sleeve portion 322. The sleeve portion 322 is sleeved onto the outer edge of the chassis 311 of the host 310 and at least exposes a front surface of the host 310. The wearing portion 321 has a plurality of accommodating spaces respectively configured to accommodate the backup power modules 330. The accommodating spaces are connected to an edge of the chassis 311 of the host 310. The electrical connection ports 314 are located at the edge and respectively located in the accommodating spaces. In the present embodiment, the accommodating spaces are hollow portions 321a, but the present disclosure is not limited in this regard.

As shown in FIG. 5, the wearing member 320 further has a plurality of first engagement structures 321b respectively disposed in the hollow portions 321a. Each of the backup power modules 330 further has a power contact 331 and a second engagement structure 332. The power contacts 331 are configured to respectively couple the electrical connection ports 314 when the backup power modules 330 are respectively accommodated in the hollow portions 321a. With the engaging design of the first engagement structures 321b and the second engagement structures 332, the backup power modules 330 can be effectively fixed in the hollow portions 321a of the wearing portion 321 without separating, so as to ensure the power contacts 331 can be firmly coupled to the electrical connection ports 314. In the present embodiment, the first engagement structures 321b of the wearing member 320 are engaging grooves formed at the inner walls of the hollow portions 321a, and the second engagement structures 332 of the backup power modules 330 are engaging blocks, but the present disclosure is not limited in this regard. In addition, in the present embodiment, the electrical connection port 314 and the first engagement structure 321b in each of the hollow portions 321a are respectively located at opposite sides, and the power contact 331 and the second engagement structure 332 on each of the backup power modules 330 are respectively located at opposite sides, but the present disclosure is not limited in this regard.

In practical applications, the number of the hollow portions 321a on the wearing portion 321 and the number of the backup power modules 330 are not limited by the present embodiment and can be flexibly adjusted as needed.

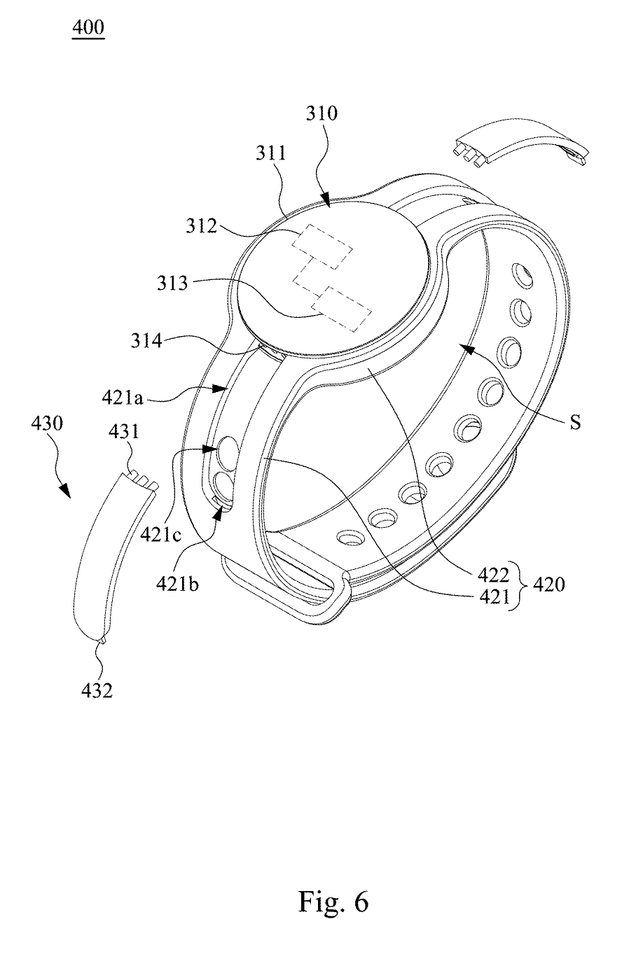

Reference is made to FIG. 6. FIG. 6 is a perspective view of a wearable electronic device 400 according to another embodiment of the disclosure, in which backup power modules 430 are separated from a wearing member 420. As shown in FIG. 6, in the present embodiment, the wearable electronic device 400 includes the host 310, the wearing member 420, and a plurality of the backup power module 430 (only one of the backup power modules 430 is labeled in FIG. 6), in which the chassis 311, the functional module 312, the main power module 313, and the electrical connection ports 314 included in the host 310 are substantially the same as the similar components in the embodiment shown in FIG. 5, so the structures and functions of these components can be referred to foregoing related descriptions and therefore are not repeated here to avoid duplicity. In addition, the wearing member 420 includes a wearing portion 421, a sleeve portion 422, and first engagement structures 421b. Each of the backup power modules 430 further has a power contact 431 and a second engagement structure 432, in which the sleeve portion 422, the power contact 431, the first engagement structures 421b, and the second engagement structures 432 are substantially the same as the similar components in the embodiment shown in FIG. 5, so the structures and functions of these components can be referred to foregoing related descriptions and therefore are not repeated here to avoid duplicity.

It should be pointed out that a difference between the present embodiment and the embodiment of FIG. 5 is that the accommodating spaces of the wearing portion 421 are indentations 421a (i.e., the accommodating spaces do not pass through the wearing portion 421). In addition, the wearing portion 421 is configured to surround to form a wearing space S, so as to accommodate a user's body (e.g., arm, wrist, ankle, neck, or other parts). Furthermore, the indentations 421a and the wearing space S are respectively located at opposite sides of the wearing portion 421. Therefore, the backup power modules 430 will not contact the user's body while being accommodated in the indentations 421a, so as to prevent the user from directly feeling the heat produced during the operation of the backup power modules 430.

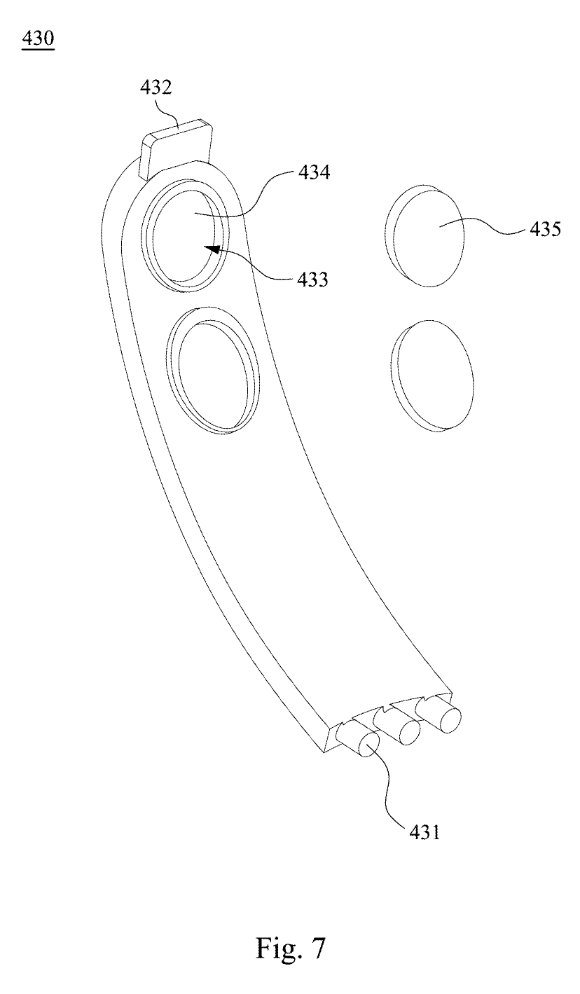

Reference is made to FIG. 7. FIG. 7 is an exploded view of a backup power module 430 shown in FIG. 6. As shown in FIG. 7, in the present embodiment, the housing of the backup power module 430 has a plurality of battery bays 433 (only one of the battery bays 433 is labeled in FIG. 7). The battery bays are configured to respectively accommodate a plurality of external batteries 435 (only one of the external batteries 435 is labeled in FIG. 7). The backup power module 430 further includes a plurality of conductive contacts 434 (only one of the conductive contacts 434 is labeled in FIG. 7). The conductive contacts 434 are respectively disposed in the battery bays 433 and configured to respectively couple the external batteries 435, so as to make the external batteries 435 supply power to the backup power module 430. In addition, when the backup power module 430 is accommodated in the corresponding indentation 421a and electrically couples the corresponding electrical connection port 314, the corresponding battery bay 433 faces a bottom of the corresponding indentation 421a. As shown in FIG. 6, the wearing portion 421 further has recesses 421c at the bottoms of the indentations 421a, so as to partially accommodate the external batteries 435. Therefore, the external batteries 435 installed on the backup power modules 430 can be retained between the wearing portion 421 and the backup power modules 430 without exposing from the indentations 421a, so as to prevent the external batteries 435 from leaving the battery bays 433 of the backup power module 430 owing to collisions.

In practical applications, the number of the battery bays 433 on the housing of the backup power module 430 and the number of the external batteries 435 are not limited by the present embodiment and can be flexibly adjusted as needed.

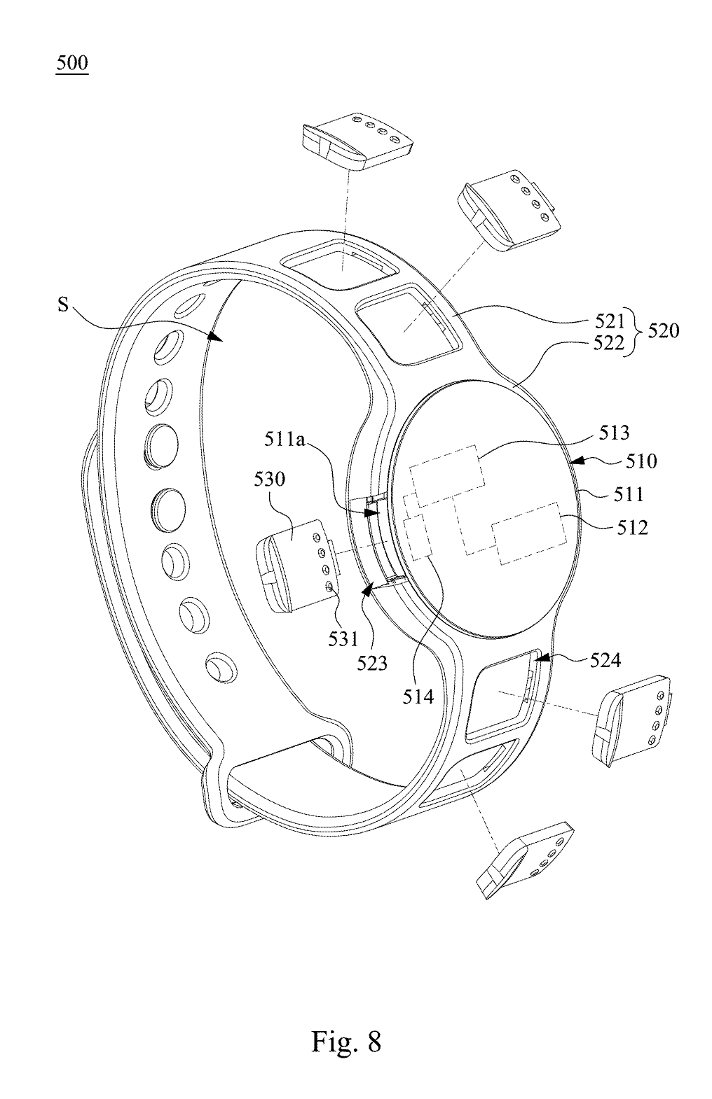

Reference is made to FIG. 8. FIG. 8 is a perspective view of a wearable electronic device 500 according to another embodiment of the disclosure, in which backup power modules 530 are separated from a wearing member 520. As shown in FIG. 8, in the embodiment, the wearable electronic device 500 includes a host 510, the wearing member 520, and a plurality of the backup power modules 530 (only one of the backup power modules 530 is labeled in FIG. 8). The host 510 includes a functional module 512, a main power module 513, and an electrical connection port 514. The main power module 513 is configured to supply power to the functional module 512. The electrical connection port 514 is 5 electrically connected to the main power module 513. The wearing member 120 is connected to the host 110. The backup power modules 530 are detachably disposed on the wearing member 520 and configured to electrically couple the electrical connection port 514, so as to supply power to the main power module 513.

Specifically, the host 510 further includes a chassis 511. The functional module 512 and the main power module 513 are disposed in the chassis 511, so they are shown in dashed lines in the figure. The chassis 511 has a slot 511a. The electrical connection port 514 is disposed in the slot 511a, so the electrical connection port 514 is shown in dashed lines in the figure. The backup power modules 530 are configured to insert into the slot 511a to electrically couple the electrical connection port 514. In addition, the wearing member 520 includes a wearing portion 521 and a sleeve portion 522. The sleeve portion 522 is connected to the wearing portion 521 and sleeved onto an outer edge of the chassis 511. The sleeve portion 522 has a guide groove 523 configured to guide the backup power modules 530 to insert into the slot 511a (i.e., the guide groove 523 is connected to the slot 511a). The wearing portion 521 has a plurality of indentations 524 (only one of the indentations 524 is labeled in FIG. 8), and the indentations 524 are configured to accommodate the backup power modules 530. Therefore, in order to supply power to the main power module 513 in the chassis 511, one of the backup power modules 530 accommodated in the indentations 524 can be inserted into the slot 511a of the chassis 511 via the guide groove 523 of the sleeve portion 522, so as to make the backup power module 530 inserting into the slot 511a be electrically coupled to the electrical connection port 514 in the slot 511a. After the power of the backup power module 530 inserting into the slot 511a runs out, the backup power module 530 can be replaced by another one of the backup power modules 530 located in other indentations 524 to continuously supply power to the main power module 513.

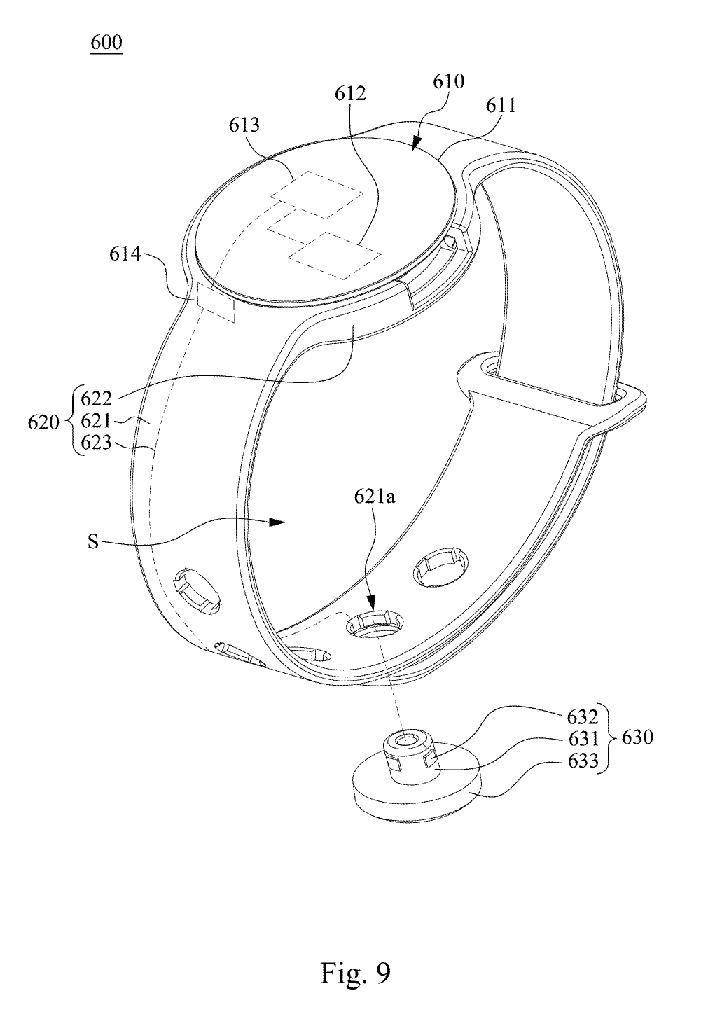

Reference is made to FIG. 9. FIG. 9 is an exploded view of a wearable electronic device 600 according to another embodiment of the disclosure, in which a backup power module 630 is separated from a wearing member 620. As shown in FIG. 9, in the embodiment, the wearable electronic device 600 includes a host 610, the wearing member 620, and the backup power module 630. The host 610 includes a chassis 611, a functional module 612, a main power module 613, and an electrical connection port 614. The functional module 612 and the main power module 613 are disposed in the chassis 611, so they are shown in dashed lines in the figure. The electrical connection port 614 is electrically connected to the main power module 613. The backup power module 630 is detachably disposed on the wearing member 620 to electrically couple the electrical connection port 614 via the wearing member 620, so as to supply power to the main power module 613.

Specifically, the backup power module 630 has an insertion portion 631 and a power contact 632 disposed on the insertion portion 631. The wearing member 620 includes two wearing portions 621, a sleeve portion 622, and at least one wire 623 (shown in a dashed line). The sleeve portion 622 is connected to the wearing portions 621 and sleeved onto an outer edge of the chassis 611. The wearing portions 621 surround to form a wearing space S. Each of the wearing portions 621 has at a plurality of through holes 621a (only one of the through holes 621a is labeled in FIG. 9). The insertion portion 631 is configured to selectively insert into one of the through holes 621a of one of the wearing portions 621 and one of the through holes 621a of another of the wearing portions 621, so as to adjust a size of the wearing space S. The wire 623 is embedded in at least one of the wearing portions 621 and coupled to the electrical connection port 614. When the insertion portion 631 inserts into one of the through holes 621a, the power contact 632 is coupled to the wire 623 via an inner wall of the through hole 621a, so as to make the backup power module 630 to supply power to the main power module 613.

Furthermore, as shown in FIG. 9, the inner wall of the through hole 621a exposes a plurality of portions of the wire 623, so a user can selectively make the power contact 632 on the insertion portion 631 couple the portions of the wire 623 exposed from the inner wall of the through hole 621a by rotating the backup power module 630 after the insertion portion 631 of the backup power module 630 inserts into the through hole 621a. Therefore, a user can decide the timing of using the backup power module 630 to supply power to the main power module 613 in the chassis 611.

In addition, the backup power module 630 further has a head portion 633 connected to the insertion portion 631. An outer diameter of the head portion 633 is greater than a diameter of the through hole 621a. Therefore, the head portion 633 of the backup power module 630 can be hold by a user to conveniently perform operations such as inserting the insertion portion 631 into the through hole 621a or rotating the entire backup power module 630.

According to the foregoing recitations of the embodiments of the disclosure, it can be seen that the wearable electronic device of the present disclosure allows the backup power module to be detachably disposed at an upper region or a surrounding region of the host to supply power to the main power module, or to be detachably disposed on the wearing member and configured to electrically couple the electrical connection port to supply power to the main power module. Therefore, the wearable electronic device of the present disclosure can conveniently supply power to the main power module in the host by using the backup power module, and the backup power module does not affect user's wear comfort and the functional operations on the host during charging.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A wearable electronic device, comprising:
a host comprising:
a functional module;
a main power module configured to supply power to the functional module; and
an electrical connection port electrically connected to the main power module;
a wearing member connected to the host; and
a backup power module detachably disposed at an upper region of the host to electrically couple the electrical connection port, so as to supply power to the main power module.

2. The wearable electronic device of claim 1, wherein the backup power module is rotatably sleeved onto an outer edge of the wearing member.

3. The wearable electronic device of claim 2, wherein the wearing member has a first engagement structure, the backup power module has a second engagement structure, and the wearing member and the backup power module rotating relative to each other make the first engagement structure be selectively engaged with the second engagement structure.

4. The wearable electronic device of claim 3, wherein the electrical connection port is disposed at an outer edge of the host, the wearing member further comprises a relay contact coupled to the electrical connection port, the backup power module further comprises a power contact, and when the first engagement structure and the second engagement structure are engaged with each other, the power contact is coupled to the relay contact.

5. A wearable electronic device, comprising:
a host comprising:
a functional module;
a main power module configured to supply power to the functional module; and
an electrical connection port electrically connected to the main power module;
a wearing member connected to the host; and
a backup power module detachably disposed at a surrounding region of the host to electrically couple the electrical connection port, so as to supply power to the main power module.

6. The wearable electronic device of claim 5, wherein the electrical connection port is disposed at a back surface of the host.

7. The wearable electronic device of claim 6, wherein the wearing member comprises a sleeve portion, the sleeve portion is sleeved onto an outer edge of the host and at least exposes the electrical connection port, and the backup power module further comprises:
an abutting portion configured to abut against the sleeve portion;
an extending portion connected to the abutting portion and configured to face the back surface of the host when the abutting portion abuts against the sleeve portion; and
a power contact disposed at the extending portion and configured to couple the electrical connection port.

8. A wearable electronic device, comprising:
a host comprising:
a functional module;
a main power module configured to supply power to the functional module; and
at least one electrical connection port electrically connected to the main power module;
a wearing member connected to the host; and
at least one backup power module detachably disposed on the wearing member and configured to electrically couple the electrical connection port to supply power to the main power module.

9. The wearable electronic device of claim 8, wherein the wearing member comprises a wearing portion, the wearing portion has at least one accommodating space configured to accommodate the backup power module, the accommodating space is connected to an edge of the host, and the electrical connection port is located at the edge.

10. The wearable electronic device of claim 9, wherein the accommodating space is an indentation.

11. The wearable electronic device of claim 10, wherein the wearing portion is configured to surround to form a wearing space, and the indentation and the wearing space are respectively located at opposite sides of the wearing portion.

12. The wearable electronic device of claim 10, wherein a housing of the backup power module has at least one battery bay, the battery bay is configured to accommodate an external battery, the backup power module further comprises a conductive contact, the conductive contact is disposed in the battery bay and configured to couple the external battery, so as to make the external battery supply power to the backup power module.

13. The wearable electronic device of claim 12, wherein the backup power module is accommodated in the indentation and coupled to the electrical connection port, and the battery bay faces a bottom of the indentation.

14. The wearable electronic device of claim 8, wherein the wearing member comprises a wearing portion, the wearing portion has at least one accommodating space configured to accommodate the backup power module, and the accommodating space is a hollow portion.

15. The wearable electronic device of claim 8, wherein the host further comprises a chassis, the functional module and the main power module are disposed in the chassis, the chassis has a slot, the electrical connection port is disposed in the slot, the backup power module is configured to insert into the slot to electrically couple the electrical connection port.

16. The wearable electronic device of claim 15, wherein the wearing member comprises:
a wearing portion; and
a sleeve portion connected to the wearing portion and sleeved onto an outer edge of the chassis.

17. The wearable electronic device of claim 16, wherein the sleeve portion has a guide groove configured to guide the backup power module to insert into the slot.

18. The wearable electronic device of claim 8, wherein the backup power module has an insertion portion and a power contact disposed on the insertion portion, and the wearing member comprises:
at least one wearing portion having at least one through hole configured to be inserted by the insertion portion; and
at least one wire embedded in the wearing portion and coupled to the electrical connection port,
wherein when the insertion portion inserts into the through hole, the power contact is coupled to the wire via an inner wall of the through hole, so as to make the backup power module to supply power to the main power module.

19. The wearable electronic device of claim 18, wherein two of the wearing portions surround to form a wearing space, each of the wearing portions has a plurality of through holes, and the insertion portion is configured to selectively insert into one of the through holes of one of the wearing portions and one of the through holes of another of the wearing portions, so as to adjust a size of the wearing space.

20. The wearable electronic device of claim 18, wherein the backup power module further has a head portion connected to the insertion portion, and an outer diameter of the head portion is greater than a diameter of the through hole.
